(19) United States
(12) Patent Application Publication
(10) Pub. No.: US 2007/0063522 A1
(43) Pub. Date: Mar. 22, 2007

(54) Lifting assembly

(76) Inventor: Vincent Byrne, Schotland (GB)

Correspondence Address: HEAD, JOHNSON & KACHIGIAN, 228 W 17TH PLACE, TULSA, OK, 74119, US

(21) Appl. No.: 11/520,084

(22) Filed: Sep. 13, 2006

(30) Foreign Application Priority Data
Sep. 15, 2005 (EP) 05108454.9

(51) Int. Cl. B66C 1/12

(52) U.S. Cl. 294/74

(57) ABSTRACT

A lifting assembly for lifting a load comprises a clamp and a rope. The rope has at least one end that is provided with an eye. The clamp is provided with a first body member and a second body member. The body members each comprise a receiving portion. The body members can be attached to each other such that the receiving portions form a through passage for receiving the rope. The assembly is adapted such that during use the rope extends through the eye. The rope thus forms a rope sling having a reeved eye. The rope has a stretched diameter, when the rope is under tension of the load, and an unstretched diameter, when the rope is unloaded. The unstretched diameter is slightly larger than the stretched diameter. The internal diameter of the through passage is adapted such that the passage clamps the rope having the unstretched diameter and releases the rope having the stretched diameter.

### CROSS-REFERENCE TO RELATED APPLICATIONS

This application claims priority to European Patent Application No. 05108454.9 filed 15 Sep. 2005.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The invention relates to a lifting assembly for lifting a load, comprising a clamp and a rope having a coupling element at one end thereof, which clamp comprises a through passage for receiving the rope and a holding member for holding the coupling element of the rope, and wherein during lifting the part of the rope between the coupling element thereof and the passage of the clamp forms a tightenable noose of rope.

The tightenable noose of rope for engaging the load is known as a reeved eye. A rope having a reeved eye is referred to as rope sling. Rope slings are commonly used in industry and construction for lifting objects, such as a bundle of pipes or other objects. When lifted the rope slings tighten around the bundle.

2. Description of the Related Art

U.S. Pat. No. 2,867,026 discloses a sliding hook for a rope. The hook includes a body provided at one end with a return bend forming a hook portion. The shank end of the body comprises a through passage that is substantially larger in diameter at the center portion thereof than the rope. A resilient frictional gripping member is arranged in the passage to grip the rope between the gripping member and the opposite side of the passage. The spacing between that side and the gripping member is less than the diameter of the rope. On the one hand, the rope is gripped sufficiently to support approximately twice the weight of the sliding hook. Thus, the hook will remain in its position when left unattended. On the other hand, the grip is light such that the hook will be automatically pulled down toward the load to tighten the sling thereon. In other words, the hook will hold against gravity sliding on the rope but will substantially slide when placed under load.

This known sliding hook requires a resilient gripping member. When the resilient gripping member slides along the wire rope for tightening the sling, the resilient gripping member still exerts some compressional forces onto the wire rope. Otherwise, the resilient gripping member would not clamp the rope firmly enough for fixing the sliding hook when the rope does not lift. Therefore, both the resilient gripping member itself and the wire rope will wear down during use, which reduces the certified working life thereof. In view of safety, each rope sling is certified for a specific working load limit, e.g. 1000 kg. The working load limit of the assembly comprising the sliding hook and the rope will decrease.

According to U.S. Pat. No. 2,867,026 the eye of the rope is held by the hook portion of the sliding hook. This hook portion is upwardly open, so that it cannot be assured that the eye is secured in position. In particular during operation, e.g. when a bundle of pipes is stacked onto the sliding hook, the eye can release itself.

According to the present invention, the reeved eye for engaging the load is formed by passing one end of the rope through the eye at the opposing end of the rope. Thus, the rope passes through the eye of the rope, which means it is guaranteed that the rope is safely secured.

Furthermore, the sliding hook disclosed in U.S. Pat. No. 2,867,026 is an integral part of the lifting assembly. It does not comprise two body members that can be attached to each other. As a result, this known sliding hook is not suitable for use with a rope that passes through the eye at one end of the rope.

Moreover, the sliding hook according to U.S. Pat. No. 2,867,026 is relatively unsafe while lifting multiple objects, such as a bundle of pipes. The shank portion of sliding hook is interposed between the eye of the rope and the rope passing through the passage. This leaves open a relatively large V-shaped gap above the uppermost pipe of the bundle. Therefore the uppermost pipe of the bundle is not securely fixed. An operator cannot force the sliding hook downwards, as it has the tendency to slide back up and this would violate regulations.

It is noted that GB Patent No. 2193747 discloses a lifting assembly having a rope sling. The clamp of this assembly consists of two symmetrical U-shaped halves, which are hinged together. The clamp can be releasably secured by two screws, each passing through the two halves of the clamp at the opposite end to that which is hinged. On each internal face of the clamp there is a semi-circular indentation shaped so as to match the rope. When the clamp is closed the two U-shaped halves come together and encompass the rope above and below the eye of the rope at one end thereof. Thus, the two U-shaped halves provide a closed end which restrains the reeved eye thereby holding the reeved eye in place.

In as much the description of GB Patent No. 2193747 can be understood, fitting this clamp to a rope sling causes substantial damage to the wire rope. First, an operator will bundle lengths of material like pipes together by wrapping rope slings around the bundle. After lifting the bundle, the slings tighten around the bundle and the clamp has to be fitted onto the rope sling. Then, the clamp has a fixed position on the live wire, i.e. the eye cannot slide along the rope. This means the closed clamp grips the live wire of the rope when it has been stretched by the load. Thus, the clamp compresses the stretched rope when it is under tension. This leads to frictional and compressional damage to the rope. After hoisting the specific working load limit for which this rope sling is certified, the damaged sling cannot be used again for the same working load limit.

It is further noted that GB Patent No. 1515107 discloses a sling for use in lifting loads. The sling comprises a clamp having a clamping pin for insertion into a groove. The pin shank slides wedgewise upwards and inwards into engagement with the rope to clamp the rope against the wall and so lock the rope securely against running movement. Thus the rope is also damaged which reduces its working load limit. After its initial use, the rope is no longer certified for the same load.

### BRIEF SUMMARY OF THE INVENTION

An object of the invention is to provide an assembly for lifting a load, which increases the useful working life of the rope sling.

This object is achieved in that the rope has a stretched diameter when the rope is under tension of the load, and an unstretched diameter when the rope is unloaded, wherein the unstretched diameter is slightly larger than the stretched diameter, and in that the internal diameter of the through passage and the rope are mutually adapted such that the passage clamps the rope having the unstretched diameter and releases the rope having the stretched diameter. The stretched diameter of a specific rope depends on the rope diameter when not under tension, the load applied to the rope and the stretchability of the rope. According to the present invention the stretching characteristics of the rope are suitable for clamping the rope in the passage when the load is laid down and releasing the rope during lifting. The internal diameter of the passage in the clamp and the specific rope used are mutually adjusted such that the clamp does not compress the rope when it is under tension of the load, e.g. 1000 kg, while after releasing the load the rope thickens slightly so as to be clamped in the passage. As a result, the clamp only compresses the rope when this is required—when the load is laid down. During lifting or lowering the load, the clamp does not exert substantial compressional forces to the rope as it is stretched as a result of the tension therein. Although the stretched rope can still contact the internal walls of the passage of the clamp during lifting, the stretched rope according to the present invention will more or less freely slide through the passage. Then, hoisting a load does not appreciably wear down the rope and, consequently, the rope sling does not experience a substantial decrease of the safe working load. Thus, the useful working life of the rope sling is increased.

A further advantage of the invention is that the combination of a specific wire rope and a specific internal diameter of the passage in the clamp provides a fixed relation. The clamp always applies the correct compression forces onto the unstretched rope. An operator cannot screw the clamp according to the invention too tight or too slight.

A still further advantage of the invention is that the structure is very simple. The clamp according to the invention does not require a relatively complex resilient gripping member.

It is preferred, according to the present invention, that the internal diameter of the through passage of the clamp is equal to or smaller than the unstretched diameter of the rope and larger than the stretched diameter of the rope. As mentioned above, the stretched diameter of the rope depends inter alia on the tension in the rope, which is caused by the load applied. A higher load will cause a smaller stretched diameter. After removal of the load, the rope expands marginally to its unstretched diameter. Depending on the relation between the internal diameter of the passage and the rope diameter, the stretched rope according to the invention may be in loose or close contact with the internal walls of the passage. Preferably, the internal diameter of the passage is larger than the stretched diameter of the rope. Then, the stretched rope can freely slide through the passage. If the internal diameter of the passage is equal to or even slightly less than the stretched rope diameter, the rope will experience increased wear while sliding through the passage. However, this wear is still little compared to the wear of the rope extending through the known sliding hook discussed above. The relation between the internal diameter of the through passage in the clamp and the stretched rope diameter depends on the desired operation.

In general, the through passage of the clamp according to the invention will be essentially undeformable such that the internal diameter of the passage is fixed. In this case, the internal diameter of the passage in the clamp cannot vary. The slipping of the rope through the passage when the rope is under load is caused entirely by the stretching of the rope.

In a preferred embodiment of the invention, the coupling element comprises an eye, and the clamp is provided with a first body member and a second body member, which body members each comprise a receiving portion, wherein the body members can be attached to each other such that the receiving portions form the through passage, and wherein during use the rope extends through the eye. This involves several advantages, as will now be elucidated.

According to the present invention, it is possible that the holding member comprises a hook element that is attached to at least one body member of the clamp, and wherein the hook element is adapted for holding the eye of the rope, which is formed by a fixed loop at one end of the rope, when the rope extends through the eye and the passage. The rope is passed through the eye for defining a reeved eye for engaging the load. The hook element encompasses the eye of the rope, i.e. the hook element grips around the wire of the eye from the side. The body member having the hook element is attached to the other body member. Together the body members encompass around the rope above the eye. Thus, the rope extending through the passage essentially runs along the longitudinal axis of the clamp during lifting. In other words, the clamp will orientate itself to the direction of the angle of the wire. The mutual alignment of the rope and the clamp during lifting further reduces the risk of imparting compressional forces onto the rope under tension. Moreover, the reeved eye tightens firmly in this case.

In an embodiment of the invention, the hook element protrudes with respect to the body parts, and wherein the hook element has a curved shape that is adapted for holding the eye. The curved shape of the hook element essentially corresponds to the stretched and unstretched diameter of the rope.

In this case, the hook element has an open side for inserting the eye of the rope in the hook element, and wherein the rope, when extending through the passage of the clamp, confines the eye of the rope received in the hook element. Thus, the assembly is adapted such that during use the eye of the rope is caught between the hook element and the rope that extends through the passage.

According to the invention, it is possible that the rope has a pulling end that is opposed to the end having the eye, and wherein the pulling end is suitably arranged for connection with a hook or other lifting or hauling device. For example, the pulling end is provided with a further eye that can be held by a crane hook.

The rope can comprises a number of materials. Advantageously, the rope comprises a steel wire. A steel wire is commonly used for off-shore applications.

The invention further relates to a clamp for a lifting assembly as described above. In particular, such a clamp can be described in independent form as a clamp for a rope, comprising a through passage for receiving the rope and a holding member for holding a coupling element at one end of the rope. The dimensions of the through passage of the clamp are adapted for clamping a rope when unloaded and releasing said rope when under tension. Advantageously, the coupling element comprises an eye, and the clamp is provided with a first body member and a second body member, which body members each comprise a receiving portion, wherein the body members can be attached to each other such that the receiving portions form the through passage for receiving the rope. Preferably, the holding member comprises a hook element that is attached to at least one body member of the clamp, and wherein the hook element is adapted for holding the eye of the rope when the rope extends through the eye and the passage.

### BRIEF DESCRIPTION OF THE DRAWINGS

An embodiment of the invention will now be described by way of example with reference to the accompanying drawings.

FIG. 1 shows a perspective view of two assemblies for lifting a load according to the invention lifting a bundle of pipes.

FIG. 2 shows a perspective view of one assembly for lifting a load shown in FIG. 1.

FIG. 3 shows an exploded view of the clamp of the assembly shown in FIG. 2.

FIG. 4 shows a side view of the clamp shown in FIG. 3.

### DETAILED DESCRIPTION OF THE INVENTION

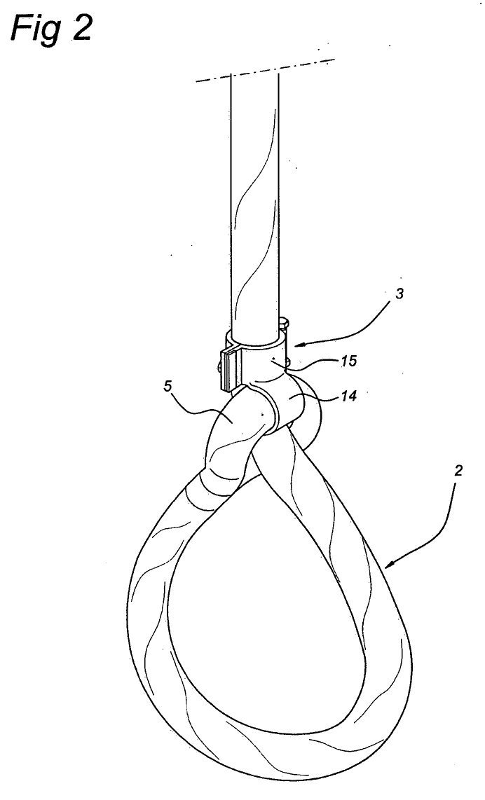

The assembly for lifting a load 1 according to the invention comprises a wire rope 2 and a clamp 3. The rope 2 has an eye 5, which is formed by a fixed loop at one end of rope 2. The end of the rope opposed to eye 5 provides a pulling end. The pulling end may also comprise a further eye that will be held by a crane or other hoisting device in operation (not shown). Rope 2 forms a reeved eye for engaging the load by passing the pulling end of rope 2 through eye 5 as can be seen in FIG. 2. Rope 2 thus constitutes a rope sling.

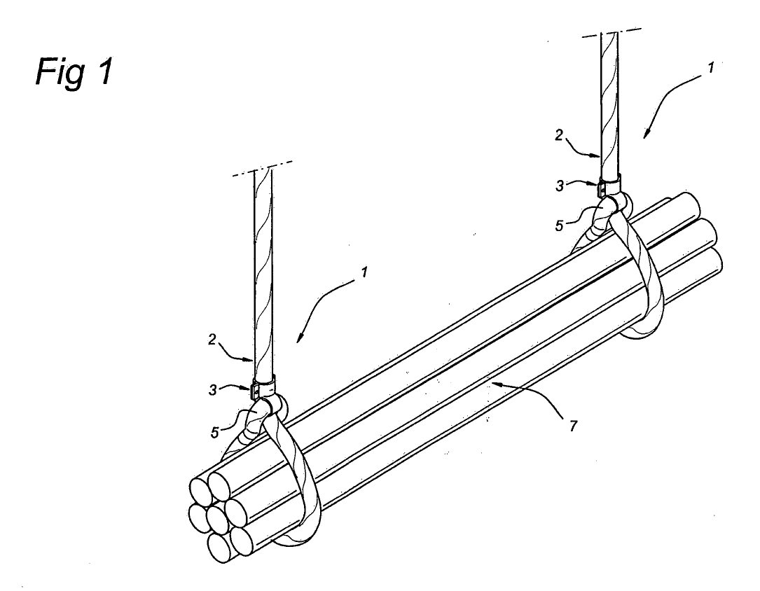

FIG. 1 shows that two rope slings are tightly noosed around a plurality of pipes 7 to form a pipe bundle. In this exemplary embodiment, the ropes extend along the vertical during lifting. This implies that two hoisting devices, e.g. two hooks, are provided, each hook lifting one rope, respectively. In practice, the two ropes are usually connected to one single hoisting device. Then, the ropes are inclined with respect to the vertical. This influences the working load limit of the rope slings.

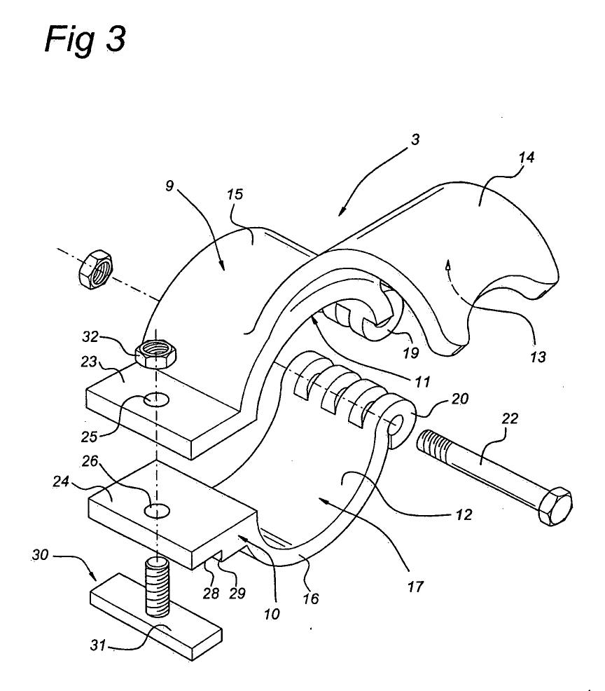

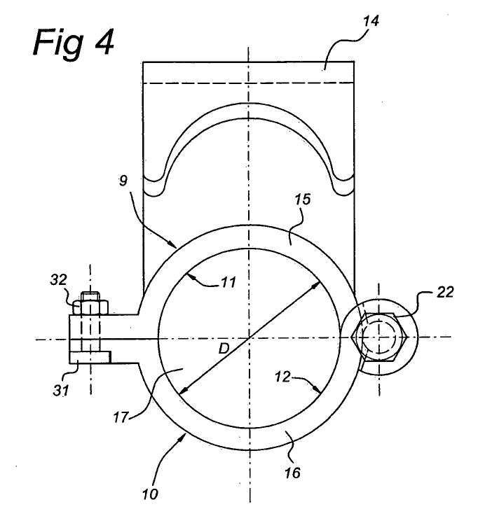

Now referring to FIGS. 3 and 4, clamp 3 comprises a first body member 9 and a second body member 10. Body member 9 has a receiving portion 15, while body member 10 has a receiving portion 16. When body members 9, 10 are attached to each other, the internal faces 11, 12 of receiving portions 15, 16 form a through passage 17.

Body member 9 comprises a hook element 14 for holding eye 5 of rope 2 when rope 2 passes through eye 5 and passage 17 (see FIG. 2). Hook element 14 protrudes from receiving portion 15 of body part 9. Hook element 14 has a curved shape that is adapted for holding eye 5. Hook element 14 has an open side 13 for inserting eye 5 of rope 2. During use, rope 2 passes through eye 5 behind the part of eye 5 that extends in hook element 14 and subsequently through passage 17. Rope 2, when extending through passage 17 of clamp 3, locks eye 5 of rope 2 when received in hook element 14.

Clamp 3 comprises attachment means for releasably connecting body members 9, 10 to each other. In this exemplary embodiment, body members 9, 10 are pivotably connected to each other at corresponding side edges of body members 9, 10. These side edges comprise hinge rings 19, 20. A hinge pin 22 can be inserted through hinge rings 19, 20. A nut 21 is provided for securing hinge pin 22.

Body members 9, 10 comprise flanges 23, 24, respectively, at the other side edges. Flange 23 of body member 9 has a first hole 25, whereas flange 24 of body member 10 is provided with a second hole 26. When body members 9, 10 are placed together, holes 25, 26 are aligned with each other. Flange 24 is provided with a recess 28 at its underside, i.e. the side facing away from flange 23 of body member 9. Thus, flange 24 has a shoulder 29 at its underside.

A bolt 30 can be inserted through the aligned holes 25, 26. Bolt 30 has a flat head 31 that can be received in recess 28 of flange 24. When head 31 abuts against shoulder 29, it prevents turning of bolt 30 in holes 25, 26. A mating nut 32 can be screwed onto bolt 30 for firmly clamping body parts 9, 10 together, as shown in FIG. 4.

In an alternative embodiment (not shown), bolt 30 is integrally formed with receiving portion 16. In this case, opening 25 is elongated such that the receiving portions 15, 16 can still hinge between an open and closed position. An operator may use one hand to close the clamp, while screwing the nut onto the shank of bolt 30 with his other hand. Thus, installing such a clamp is relatively easy.

In practice, multiple bundles of pipes are stacked onto each other in a rough manner. This may cause damage to the bolt and/or the nut, e.g. bending of the shank or damage to the thread. As shown in FIGS. 1 and 2, nut 32 and bolt 30 are located at the side and below the top of the clamp in operation. Thus, the top of the clamp protects the bolt against an impact of pipes, which reduces the risk of damage.

When body parts 9, 10 are placed onto each other, through passage 17 defined by the internal faces 11, 12 of receiving portions 15, 16 has an internal diameter D, as shown in FIG. 4. The internal diameter D of the through passage is fixed as long as the body parts are attached to each other.

In off-shore applications, rope 2 usually comprises a steel wire. When rope 2 is unloaded, it has an unstretched diameter. Rope 2 will stretch when it is under tension of a load, which will decrease the diameter of rope 2. When lifting a load rope 2 becomes thinner than in the unloaded state. Thus, the stretched diameter of the rope is marginally smaller than the unstretched diameter of rope 2. The internal diameter D of through passage 17 is adapted such that the passage clamps rope 2 when it has its unstretched diameter and releases rope 2 when it has its stretched diameter. In other words, passage 17 clamps rope 2 when the load is laid down, but the passage is inactive during hoisting of the load. During lifting of the load passage 17 does not compress rope 2—it may slide through the passage 17.

As an example, a wire rope 2 having a working load limit of 1000 kg has an unstretched diameter of 10 mm. When this wire rope 2 is under tension of the 1000 kg working load limit, its stretchability may be such that rope 2 will stretch to approximately 9 mm. Then, the internal diameter D of through passage 17 can be between 9-10 mm, e.g. 9.8 or 9.5 mm.

Obviously, the internal diameter D of passage 17 depends on the specific wire rope, in particular the unstretched diameter thereof, the certified working load limit thereof defining the load to be applied and the stretchability of the rope. It is noted that the working load limit can be between 1000-10000 kg. A larger load would increase the stretching of the rope, which leads to a larger difference between the unstretched diameter of the rope and the stretched diameter thereof. This is advantageous for the operation of the assembly according to the invention.

It is to be understood that the invention is not to be limited to the embodiment herein described and shown. The skilled person will appreciate that the invention may take various alternative forms.

1. A lifting assembly for lifting a load, the assembly comprising:
a clamp having a through passage for receiving a rope;
a rope having a coupling element at one end thereof, and wherein during lifting a part of the rope between the coupling element thereof and the passage of the clamp forms a tightenable noose of rope, and the rope further having a stretched diameter when under tension of a load, and an unstretched diameter when the rope is unloaded, wherein an unstretched diameter is slightly larger than a stretched diameter, and in that an internal diameter (D) of the passage and the rope are mutually adapted such that the passage clamps the rope having the unstretched diameter and releases the rope having the stretched diameter; and
a holding member for holding the coupling element of the rope.

2. The lifting assembly according to claim 1 wherein said internal diameter (D) of said through passage of said clamp is equal to or smaller than said unstretched diameter of said rope and larger than said stretched diameter of said rope.

3. The lifting assembly according to claim 1 wherein said through passage of said clamp is essentially undeformable such that said internal diameter (D) of the passage is fixed.

4. The lifting assembly according to claim 1 wherein said coupling element comprises an eye, and wherein said clamp is provided with a first body member and a second body member, which body members each include a receiving portion, wherein the body members can be attached to each other such that the receiving portions form the through passage, and wherein during use said rope extends through the eye.

5. The lifting assembly according to claim 4 wherein said holding member includes a hook element that is attached to at least one body member of said clamp, and wherein the hook element is adapted for holding said eye of said rope when said rope extends through said eye and said passage.

6. The lifting assembly according to claim 5 wherein said hook element protrudes with respect to said body members, and wherein said hook element has a curved shape that is adapted for holding said eye.

7. The lifting assembly according to claim 6 wherein said hook element has an open side for inserting said eye of said rope in said hook element, and wherein said rope, when extending through the passage of said clamp, confines said eye of said rope received in said hook element.

8. The lifting assembly according to claim 1 wherein said rope has a pulling end that is opposed to the end having said eye, and wherein the pulling end is provided with a further eye.

9. The lifting assembly according to claim 1 wherein said rope is a steel wire.

10. A clamp for a lifting assembly, said clamp comprising:
a first body member and a second body member each having a receiving portion and being attachable to each other such that the receiving portions form a through passage for receiving a rope having a coupling element at one end thereof including an eye;
a holding element for holding the coupling element of the rope having a hook element that is attached to at least one body member of the clamp and being adaptable for holding the eye of the rope when the rope extends through the eye and the through passage;
the through passage of the clamp has dimensions that are adapted for clamping a rope when unloaded and releasing the rope when under tension; and
an attachment means for releasably connecting the body members to each other.

11. The clamp according to claim 10 wherein said hook element protrudes with respect to said body members, and wherein said hook element has a curved shape that is adapted for holding said eye.

12. The clamp according to claim 11 wherein said hook element has an open side for inserting said eye of said rope in said hook element, and wherein said rope, when extending through the passage of said clamp, confines said eye of said rope received in said hook element.

13. The clamp according to claim 10 wherein said body members are pivotably connected to each other at corresponding side edges of each member, the side edges having hinge rings for insertion of a hinge pin secured by a nut.

14. The clamp according to claim 13 wherein said body members include flanges at a side edge, each flange has an opening for insertion of a bolt and at least one body member has a recess at its underside and a shoulder.

15. The clamp according to claim 14 wherein said bolt has a flat head receivable in the recess in at least one flange and abuts against the shoulder and further having a mating nut for screwing onto the bolt for firmly clamping the body members together.

16. The clamp according to claim 10 further having an internal diameter (D) of said through passage being equal to or smaller than an unstretched diameter of the rope and larger than a stretched diameter of the rope.

17. The clamp according to claim 10 wherein said through passage is essentially undeformable such that an internal diameter (D) of the passage is fixed.
